(19) United States
(12) Patent Application Publication
(10) Pub. No.: US 2020/0081745 A1
(43) Pub. Date: Mar. 12, 2020

(54) SYSTEM AND METHOD FOR REDUCING COLD START LATENCY OF SERVERLESS FUNCTIONS

(71) Applicant: Nuweba Labs Ltd., Tel Aviv-Jaffa (IL)

(72) Inventors: Yan CYBULSKI, Tel-Aviv (IL); Eyal AVNI, Tel-Aviv (IL)

(73) Assignee: Nuweba Labs Ltd., Tel Aviv-Jaffa (IL)

(21) Appl. No.: 16/564,525

(22) Filed: Sep. 9, 2019

Related U.S. Application Data
(60) Provisional application No. 62/728,977, filed on Sep. 10, 2018.

(51) Int. Cl. G06F 9/50; G06F 9/54; G06F 11/14

(52) U.S. Cl. CPC G06F 9/5077; G06F 11/1438; G06F 9/545

(57) ABSTRACT

A method and system for reducing a cold start latency when invoking serverless functions on a FaaS platform are provided. The method comprises migrating serverless functions to the FaaS platform; per each migrated serverless function, pre-creating a plurality of software containers with non-generic resources; distributing the pre-created non-generic software containers across nodes of the FaaS platform; pre-creating a plurality of software containers with generic resources; executing the plurality generic resources across nodes of the FaaS platform; and upon receiving a first request to invoke a migrated serverless function, merging a respective non-generic software container with a generic software container.

### CROSS-REFERENCE TO RELATED APPLICATIONS

This application claims the benefit of U.S. Provisional Application No. 62/728,977 filed on Sep. 10, 2018, the contents of which are hereby incorporated by reference.

### TECHNICAL FIELD

The present disclosure relates generally to function as a service (FaaS) cloud computing platforms, and more specifically to the optimization of cold start of serverless functions within software containers for use in functions as a service (FaaS).

### BACKGROUND

Organizations have increasingly adapted their applications to be run from multiple cloud computing platforms. Some leading public cloud service providers include Amazon®, Microsoft®, Google®, and the like. Serverless computing platforms provide a cloud computing execution model in which the cloud provider dynamically manages the allocation of machine resources. Such platforms, also referred to as function as a service (FaaS) platforms, allow execution of application logic without requiring storing data on the client's servers. Commercially available platforms include AWS® Lambda by Amazon®, Azure® Functions by Microsoft®, Google Cloud Functions® cloud platform by Google®, OpenWhisk by IBM®, and the like.

“Serverless computing” is a misnomer, as servers are still employed. The name “serverless computing” is used to indicate that the server management and capacity planning decisions of serverless computing functions are not managed by the developer or operator. Serverless code can be used in conjunction with code deployed in traditional styles, such as in microservices. Alternatively, applications can be written to be purely serverless and to use no provisioned services at all.

Further, FaaS platforms do not require coding to a specific framework or library. FaaS functions are regular functions with respect to programming language and environment. Typically, functions in FaaS platforms are triggered by event types defined by the cloud provider. Functions can also be trigged by manually configured events or when a function calls another function. For example, in Amazon® AWS® such triggers include file (e.g., S3) updates, passage of time (e.g., scheduled tasks), and messages added to a message bus. A function programmer would typically have to provide parameters specific to the event source it is tied to.

A serverless function is typically programmed and deployed using command line interface (CLI) tools, an example of which is a serverless framework. In most cases, the deployment is automatic, and the function's code is uploaded to the FaaS platform. A serverless function can be written in different programming languages, such as JavaScript®, Python®, Java®, and the like. A function typically includes a handler (e.g., handler.js) and third-party libraries accessed by the code of the function. A serverless function also requires a framework file as part of its configuration. Such a file (e.g., serverless.yml) defines at least one event that triggers the function and resources to be utilized, deployed, or accessed by the function (e.g., a database).

Some serverless platform developers have sought to take advantage of the benefits of software containers. For example, one of the main advantages of using software containers is the relatively fast load times as compared to virtual machines. However, while load times such as 100 ms may be fast as compared to VMs, such load times are still extremely slow for the demands of FaaS infrastructures. In particular, this load time is extremely slow when a new container is invoked. This time typically refers to a “cold start latency”.

Specifically, a cold start is the latency experienced when a serverless function is triggered. A cold start only happens if there is no idle software container available waiting to run the function's code. This would require invoking a new software container in the FaaS infrastructure. Once the container invokes, its instance stays alive to be reused for subsequent requests. Users have no control or visibility when containers are killed in the FaaS infrastructure. Currently measured cold start times for the different platforms are between 5 and 17 minutes for AWS® Lambda; about 20 minutes for Azure® Functions; and between 3 minutes and 15 minutes for Google® Cloud Functions.

The cold start latency negatively effects the user experience due to slow response, can cause timeouts in the calling function or through a chain reaction, and more. Thus, the cold start latency downgrades the operation of applications utilizing serverless functions. A straightforward approach for reducing the cold start latency may be achieved by keeping software containers live or keeping “warm” containers ready to serve requests. However, an such approach would require un-utilized computing resources.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein includes a computing node operable in a Function as a Service (FaaS) cloud platform system. The computing nodes comprises processing circuitry; and a memory, the memory containing instructions that, when executed by the processing circuitry, configure the system to: migrate serverless functions to the FaaS platform; per each migrated serverless function, pre-create a plurality of software containers with non-generic resources; distribute the pre-created non-generic software containers across computing nodes of the FaaS platform; pre-create a plurality of software containers with generic resources; execute the plurality generic resources across computing nodes of the FaaS platform; and merge a respective non-generic software container with a generic software container, upon receiving a first request to invoke a migrated serverless function.

Certain embodiments disclosed herein also includes a method for reducing a cold start latency when invoking serverless functions on a Function as a Service (FaaS) platform. The method comprises migrating serverless functions to the FaaS platform; per each migrated serverless function, pre-creating a plurality of software containers with non-generic resources; distributing the pre-created non-generic software containers across computing nodes of the FaaS platform; pre-creating a plurality of software containers with generic resources; executing the plurality generic resources across computing nodes of the FaaS platform; and upon receiving a first request to invoke a migrated serverless function, merging a respective non-generic software container with a generic software container.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram illustrating a function as a service (FaaS) platform utilized to describe the disclosed embodiments.

FIGS. 2A and 2B are diagrams illustrating a scalable FaaS platform designed to reduce the cold start latency according to the disclosed embodiments.

FIG. 3 is a flowchart illustrating a method for pre-creating containers in order to reduce the cold start latency.

FIG. 4 is a flowchart illustrating a method for a first time execution of a serverless function while reducing the cold start latency according to an embodiment.

FIG. 5 is a schematic diagram of a hardware layer according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for the optimization of cold start latency of serverless functions executed in software containers (or simply “containers” or a “container”). A container includes a runtime (e.g., implemented in Python®, Java®, etc.) with required dependencies and supplied code snippet from a user. The code of a serverless function executed in the container. The containers and, hence, the serverless functions are running over a FaaS.

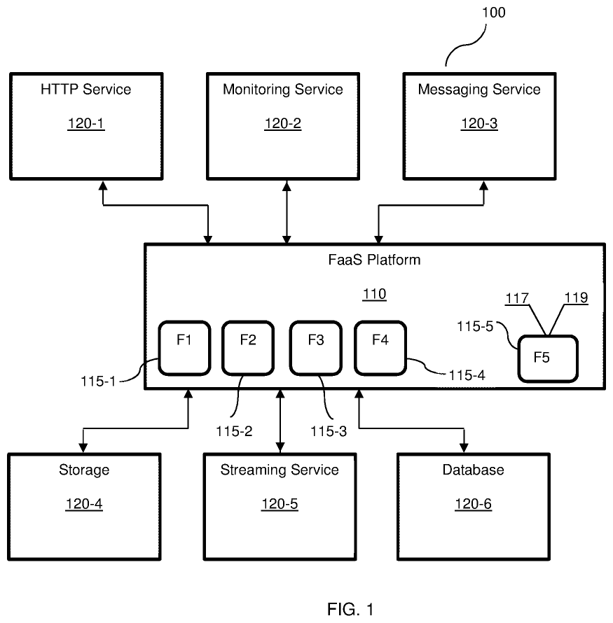

FIG. 1 shows an example diagram 100 illustrating a FaaS platform 110 utilized to describe the disclosed embodiments. The FaaS platform 110 provides serverless functions for various services 120-1 through 120-6 (hereinafter referred to as services 120 for simplicity). Each of the services 120 may utilize one or more of the serverless functions provided by the respective software containers 115-1 through 115-5 (hereinafter referred to as a container 115 or containers 115 for simplicity). Each software container 115 is configured to receive requests from the services 120 and provides functions in response.

To this end, each container 115 includes code of the respective function. A container 115 executing the function should be first instantiated and invoked on a server in the cloud infrastructure. The cold start latency is the latency from receiving a request to run a function and the latency from when the function is running. This latency includes the time for processing the request, starting (instantiating and invoking) a software container, starting a runtime environment, and starting the code of the serverless function.

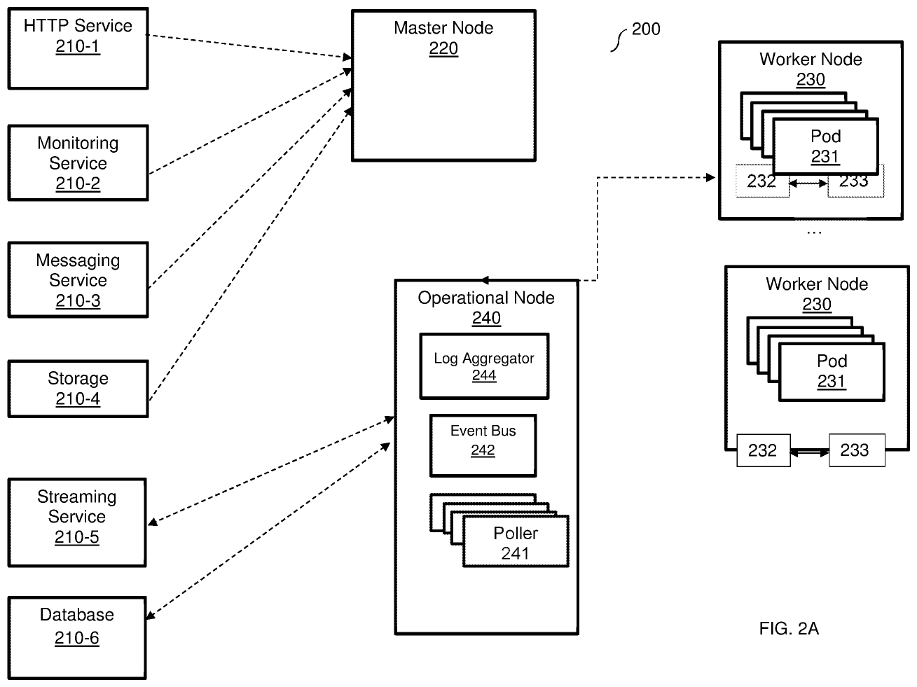

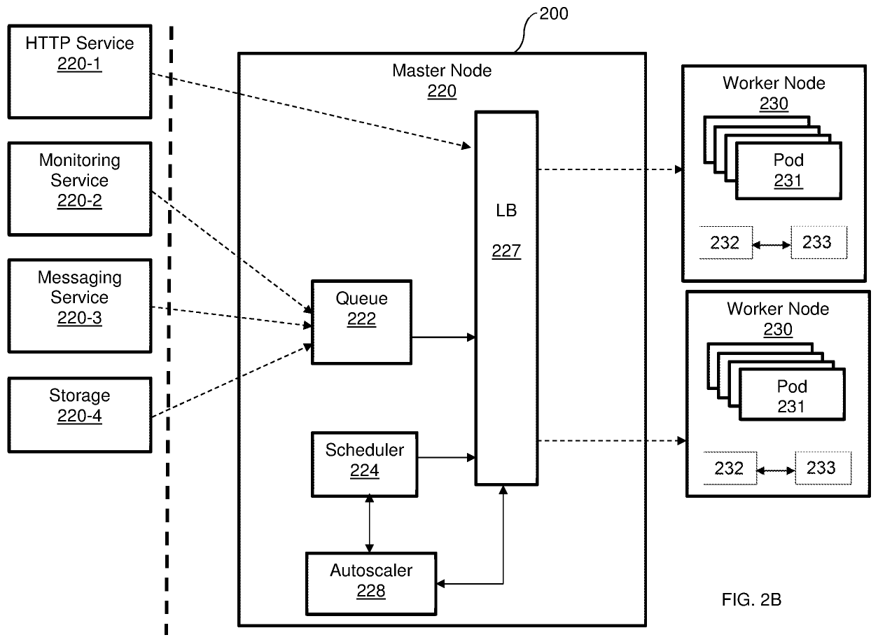

The FaaS platform 110 may support various types of functions, such as Amazon® Web Services (AWS) Lambda® functions, Azure® functions, and IBM® Cloud functions which may be provided using the pods deployed in a FaaS platform as described in FIG. 2A. The functions are services for one or more containerized application platforms (e.g., Kubernetes®). A serverless function may trigger other functions. According to some embodiments, the FaaS platform 110 is a scalable platform that can execute a proprietary's type of serverless functions. An example scalable platform is provided below with reference to FIGS. 2A and 2B.

According to some embodiments, techniques for reducing the cold start latency is disclosed. Using the disclosed techniques, such latency can be reduced to tens of milliseconds (e.g., 30 milliseconds). As mentioned above, a current FaaS platform demonstrates a cold start latency of minutes.

The reduction of the cold start latency is achieved in part through pre-creation of a container and a fast runtime load utilizing the resources of pre-created containers. Containers' resources can be classified into non-generic and generic resources.

Non-generic resources are specific per each function type, thus defining the function. Generic resources are agnostic to the function type. For example, non-generic resources may include SecComp, AppArmor, a function's filesystem, a container's function configs, cgroup, mounts, and the like. Generic resources include network interfaces, PID namespaces, network namespaces, Interprocess Communication (IPC) namespaces, UTS namespaces, user namespaces, control group (cgroup) namespaces, mount namespaces, container storage, and the like.

Each container resource consumes computing resources (e.g., CPU, memory, IO components, and so on) which may be relatively high or low, depending on the type of resource. Examples of non-generic container resources considered low computing resource consumers are: AppArmor, function filesystems, mounts, and container function configs. Examples of generic resources considered low computing resource consumers include: network interfaces, network namespaces, IPC namespaces, UTS namespaces, user namespaces, mount namespaces, and a cgroup namespaces.

One of ordinary skill should be familiar with the above-noted container resources. For example, namespaces are a feature of the Operating System (OS) kernel which partition kernel resources such that one set of processes sees one set of resources while another set of processes sees a different set of resources. Typically, the same namespace is defined for these resources in the various sets of processes, but with those names referring to distinct resources. Examples of resource names that can exist in multiple spaces so that the named resources are partitioned are process IDs, hostnames, user IDs, file names, and some names associated with network access and interprocess communication. Namespaces are a fundamental aspect of containers, particularly in Linux®.

The mount namespaces control mount points. Upon creation the mounts from the current mount, namespaces are copied to a new namespace, but mount points created afterwards do not propagate between namespaces. The PID namespace provides processes with an independent set of process IDs (PIDs) from other namespaces. Network namespaces virtualize the network stack. On creation, a network namespace contains only a loopback interface. IPC namespaces isolate processes from SysV style inter-process communication. This prevents processes in different IPC namespaces from using, for example, the SHM family of functions to establish a range of shared memory between the two processes. Instead, each process will be able to use the same identifiers for a shared memory region and produce two such distinct regions. UTS namespaces allow a single system to appear to have different host and domain names to different processes. User namespaces are a feature which provide both privilege isolation and user identification segregation across multiple sets of processes available since kernel. The cgroup namespace type hides the identity of the control group of which process is a member.

AppArmor is a Linux® kernel security module that supplements the standard Linux user and group based permissions to confine programs to a limited set of resources. SecComp is a computer security facility in the Linux kernel. The generic resources are required at runtime, while the non-generic resources are need not be created at runtime.

According to the disclosed embodiments, the pre-create stage phase includes the creation of containers with non-generic resources and containers with generic resources.

In the pre-create stage, a node in the FaaS platform 110 is configured to create non-generic resources of a container (non-generic container). In an embodiment, at least the following resources are pre-created: a mount namespace, AppArmor, a container filesystem, and container configs. Such resources are considered to consume less computing resources. The non-generic container is check-pointed and saved to a storage space in a node in the FaaS. Then, the non-generic container is copied to all other nodes in the FaaS platform 110. In the example FIG. 1, a non-generic container 117 is pre-created. It should be noted that a node in the FaaS platform 110 may include a virtual machine.

In an embodiment, a pre-created non-generic container is further added to a source container. The source container provides the physical memory for such a container, utilized when the pre-created non-generic container is loaded using, for example, a kernel copy-on-write process. It should be noted that all non-generic containers serving different instances of functions of the same type will point to the source container, including the respective non-generic container.

Then, a node in the FaaS platform 110 is configured to pre-create a container with generic resources (generic container). The pre-created generic resources include, for example, network interfaces and the container's namespaces (network, IPC, UTS, user, mount, PID, and cgroup). The pre-created generic resources are considered to consume fewer computing resources and are further restricted by the amount of computing resources they can consume (e.g., a number of VMs). In an embodiment, the pre-created generic containers are executed. In the example FIG. 1, a non-generic container 119 is pre-created.

The pre-creation of containers can be performed when the functions are deployed. That is, an application including calls for functions to be executed on the FaaS platform is analyzed and containers for serving such functions are pre-created. In an embodiment, the pre-created containers are distributed across a number of nodes of the FaaS platform. An example FaaS platform showing multiple nodes is further discussed with reference to FIG. 2A.

Upon receiving a request to run a specific function (e.g., F5), a node in the FaaS platform 110 is configured to merge the respective pre-created non-generic container (e.g., 117) with a generic container (e.g., 119) to create a function-specific container 115-5. In an embodiment, the creation of the function-specific container is initiated by a restore command which causes restoration of the pre-created non-generic container from the memory (from the checked-point), merger of the namespaces (of both containers), and configuration of non-generic resources (e.g., SecCom and PID namespace) with high consumption of computing resources.

According to one implementation, the restoration of a container from the memory is performed using a tool that allows restoration of a process from a user-space (or the kernel of the operating system) in a combination with a kernel copy-on-write technique. An example of such a memory restoration tool is Checkpoint/Restore in Userspace (CRIU), which is a software tool in Linux. As another example, memory restoration may be achieved by hibernating a virtual machine (VM) or a micro VM using, a gemu process. As another example, memory restoration may be achieved by a firecracker tool or Linux Kernel-based Virtual Machine (KVM) live migration tool. Firecracker implements a virtual machine monitor (VMM) that uses the KVM to create and manage micro-VMs.

A CRIU tool is typically configured to freeze a running process, or part thereof, and checkpoint the code to persistent memory as a collection of files. Using the CRIU tool, the files can be used to restore and run a process from the point at which it was frozen. The CRIU tool allows for a faster startup time of the application. It should be noted that the CRIU is mainly implemented in the user space and not in the kernel of the operating system. In an embodiment, the CRIU (or any equivalent) tool is modified to join namespaces already created in the containers and restore a process memory and instruction state of the pre-created non-generic container from the memory. In the restore process, the generic container is configured to receive a restore command to restore the desired function into the memory.

To further optimize a cold start latency, a copy-on-write (kCow) mechanism is used to eliminate any bottleneck created by the restore process. Such bottleneck is caused by the latency of loading of a memory file and allocating a memory space for the function to load. Specifically, in a FaaS many instances of the exact same functions are executed in parallel, each instance requiring its own memory allocation. The aggregated memory consumption, when executing many instances at one time, is reduced by sharing the same physical memory pages between the various instances of the same function. To this end, the procedure relies on the fact that both source and destination pages would contain the same data. Further, the data is shared on a read-only basis, that is, when an instance tries to write to the shared page, the instance receives its own private copy of the page, and therefore the sharing instance will not affect the other instances.

In an embodiment, a checkpoint mechanism is utilized to initialize and run each function. The checkpoint mechanism is integrated within the copy-on-write mechanism. This allows one instance of the function to stay in a “frozen state”, while other instances use it as the source. The restored instances of the same function merge their memory with the source, instead of reading contents of the function from a disk.

Each function's instance (or process) is allocated to its own virtual memory, and the addresses used by the process are virtual addresses. A virtual address is a binary number in virtual memory that enables a process to use a location in the physical memory independently of other processes and to use more space than actually exists in the physical memory by temporarily relegating some contents to a hard disk or internal flash drive. Virtual pages accessed, by function's instances, are allocated in physical memory mapped to virtual addresses.

According to the disclosed embodiments, the pre-created non-generic container is check-pointed at the moment that the process is waiting for a request to run the function. As such, when the code and relevant dependencies are loaded, the container can immediately start processing the request to run a function with the user supplied code.

It should be noted that disclosed embodiments can be implemented in any operating system (OS) and a CPU architecture. In a preferred embodiment, the disclosed embodiments can be implemented in a Linux OS and an Intel® CPU architecture.

FIG. 2A is an example diagram of a scalable FaaS platform 200 according to an embodiment. In this example embodiment, the FaaS platform 200 provides serverless functions to services 210-1 through 210-6 (hereinafter referred to individually as a service 210 or collectively as services 210 for simplicity) through the various nodes. In an embodiment, there are three different types of nodes: a master node 220, a worker node 230, and an operational node 240. In an embodiment, the scalable FaaS platform 200 includes a master node 220, one or more worker nodes 230, and one or more operational nodes 240.

The master node 220 is configured to orchestrate the operation of the worker nodes 230 and an operational node 240. A worker node 230 includes pods 231 configured to execute serverless functions. Each such pod 231 is a software container configured to perform a respective function such that, for example, any instance of the pod 231 contains code for the same function. The operational nodes 240 are utilized to run functions for the streaming and database services 210-5 and 210-6. The operational nodes 240 are further configured to collect logs and data from worker nodes 230.

In an embodiment, each operational node 240 includes one or more pollers 241, an event bus 242, and a log aggregator 244. A poller 241 is configured to delay provisioning of polled events indicating requests for functions. To this end, a poller 241 is configured to perform a time loop and to periodically check an external system (e.g., a system hosting one or more of the services 210) for changes in the state of a resource, e.g., a change in a database entry. When a change in state has occurred, the poller 241 is configured to invoke the function of the respective pod 231.

The event bus 242 is configured to allow communication between the other nodes and the other elements (e.g., the poller 241, log aggregator 244, or both) of the operational node 240. The log aggregator 244 is configured to collect logs and other reports from the worker nodes 230.

In an example implementation, the poller 241 may check the streaming service 210-5 and the database 210-6 for changes in state and, when a change in the state of one of the services 210-5 or 210-6 has occurred, invoke the function requested by the respective service 210-5 or 210-6.

In an embodiment, the master node 220 further includes a queue, a scheduler, a load balancer, and an auto-scaler (not shown in FIG. 2A), utilized during the scheduling of functions.

It should be noted that, in a typical configuration, there is a small number of master nodes 220 (e.g., 1, 3, or 5 master nodes), and a larger number of worker nodes 230 and operational nodes 240 (e.g., millions). The worker nodes 230 and operational nodes 240 are scaled on demand.

In an embodiment, the nodes 220, 230, and 240 may provide a different FaaS environment, thereby allowing for FaaS functions, for example, of different types and formats (e.g., AWS® Lambda, Azure®, and IBM® functions). The communication among the nodes 220 through 240 and the services 210 may be performed over a network, e.g., the internet (not shown).

In some implementations, the FaaS platform 200 may allow for seamless migration of functions used by existing customer platforms (e.g., the FaaS platform 110, FIG. 1). The seamless migration may include moving code and configurations to the FaaS platform 200.

FIG. 2B is an example diagram of the FaaS platform 200 utilized to describe a centralized scheduling execution of functions according to an embodiment. As detailed in FIG. 2B, the master node 220 includes a queue 222, a scheduler 224, a load balancer (LB) 227, and an auto-scaler 228. In an example embodiment, a load balancer 227 can be realized as an Internet Protocol Virtual Server (IPVS). The load balancer 227 acts as a load balancer for the pods 231 (in the worker nodes 230) and is configured to allow at most one connection at a time, thereby ensuring that each pod 231 only handles one request at a time. In an embodiment, a pod 231 is available when the number of connections to the pod is zero.

The load balancer 227 is configured to receive requests to run functions by the pods 231 and balance the load among the various pods 231. When such a request is received, the load balancer 227 is first configured to determine if there is an available pod. If so, the request is sent to the available pod at a worker node 230. If no pod is available, the load balancer 227 is configured to send a scan request to the auto-scaler 228. The auto-scaler 228 is further configured to determine the number of pods that would be required to process the function.

The required number of pods is reported to the scheduler 224, which activates one or more pods on the worker node(s) 230. That is, the scheduler 224 is configured to schedule activation of a pod based on demand. An activated pod reports its identifier, IP address, or both, to the load balancer 227. The load balancer 227 registers the activated pod and sends the received request to the newly activated pod.

According to the disclosed embodiments, the pre-created containers are pods in the worker nodes. Each worker node further implements userspace restore tool 232 and kCoW 233 mechanism in order to reduce load time of a function. When a request to run a serverless function is received, the load balancer 227 activates a new pod. A restore request is received at the userspace restore tool 232, which requests the kCoW mechanism 233 to merge a check-pointed non-generic container with a source generic container. In an example embodiment, the userspace restore tool 232 is a CRIU tool.

It should also be noted that the flows of requests shown in FIGS. 2A and 2B (as indicated by dashed lines with arrows in FIGS. 2A and 2B) are merely examples used to demonstrate various disclosed embodiments and that such flows do not limit the disclosed embodiments. It should be further noted each of the nodes (shown in FIGS. 2A, 2B) requires an underlying hardware layer (not shown in FIGS. 2A, 2B) to execute the operating system, the pods, load balancers, and other functions of the master node.

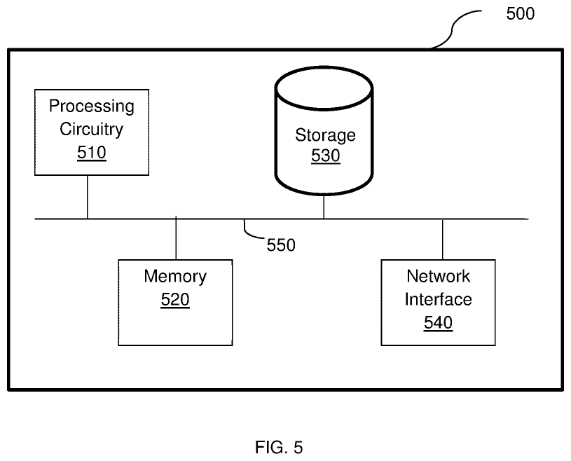

An example block diagram of a hardware layer is provided in FIG. 5. Furthermore, the various elements of the nodes 220 and 240 (e.g., the scheduler, autoscaler, pollers, event bus, log aggregator, etc.) can be realized as pods. As noted above, a pod is a software container. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). Such Instructions are executed by the hardware layer.

It should be understood that the embodiments described herein are not limited to the specific architecture illustrated in FIGS. 1, 2A and 2B, and that other architectures may be equally used without departing from the scope of the disclosed embodiments.

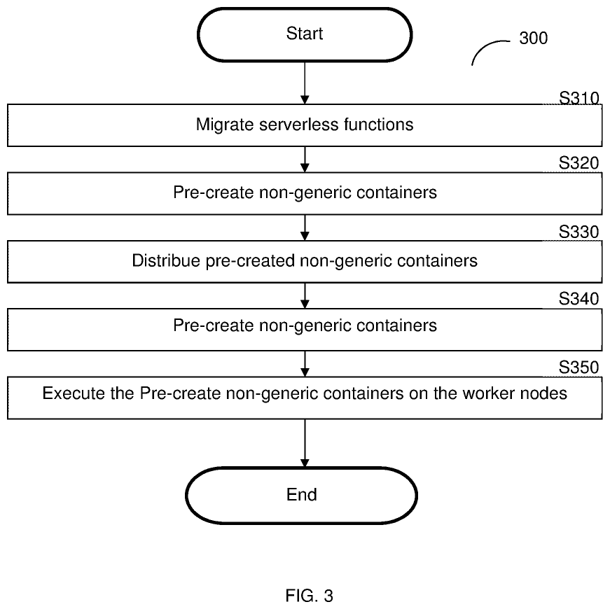

FIG. 3 shows an example diagram illustrating a method 300 for reducing the cold start latency for executing serverless functions on a FaaS platform according to an embodiment.

The process starts, at S310, with the migration of serverless functions to the FaaS platform. S310 may be triggered by transferring functions from one FaaS platform to another or executing a new application including calls to the “migrated” functions on the FaaS platform.

According to embodiments, for each such migrated function an image of the function is created using the function's code configurations. The function's code and configurations may be uploaded by a user or obtained from a central repository. The image of each function is saved to a storage space of a node. It should be noted that the created function is not executed at this stage.

At S320, containers with non-generic resources (“non-generic containers”) are pre-created. In an embodiment, the non-generic resources are resources defining the respective function and characterized by low consumption of computing resources. Examples of such resources include AppArmor, a function filesystem, and a container's function configs. A number, ‘ft’ of non-generic containers is pre-created for each migrated function, where ‘R’ is an integer number greater than 1 and is a function of the number parallel executions that should be supported by the function. In an embodiment, the non-generic container is check-pointed and saved to a storage space of a node which is added to a source container, adding each non-generic software container to a source container, wherein the source container provides the physical memory of each non-generic software container for its respective serverless functions.

At S330, the pre-created non-generic containers are distributed across worker nodes. In an embodiment, each worker nodes is assigned an equal number of non-generic containers pre-created for a function. For example, if there are three functions, each function supporting 1,000 (R=1000) parallel executions in total, 3,000 pre-created containers will be produced. If the FaaS platform includes 5 worker nodes, each such node is assigned 200 pre-created containers per function, and a total of 600 pre-created containers.

At S340, containers with generic resources (“generic containers”) are pre-created. In an embodiment, the generic resources are resources with low consumption of computing resources. Examples of such resources include network interfaces, the container's namespaces (IPC, mount, UTS, user, and cgroup) and the other files required to create such containers. At least one generic container is pre-created and assigned for each worker node. A pre-created generic container is a container that can support any of the functions and their respective non-generic containers. Thus, the generic container is a general container with no identity.

At S350, in an embodiment, the generic containers are executed by the worker nodes and their consumption of computing resources is limited. At this stage, the generic containers, when executed, do not serve any specific function. It should be noted that the generic and non-generic containers can be realized as pods in the worker nodes.

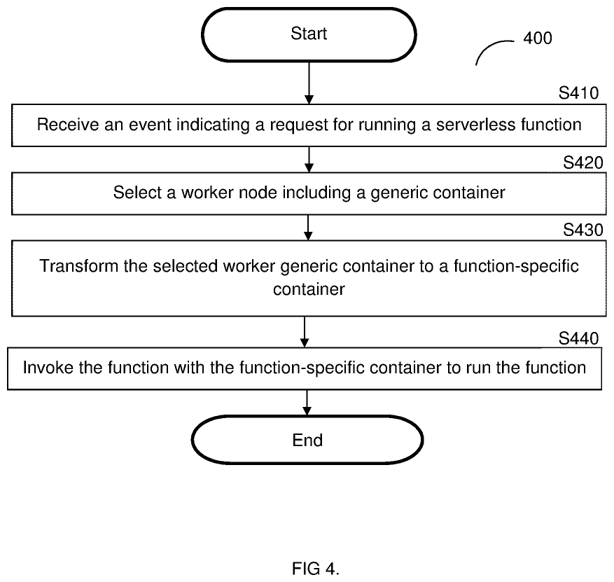

In an embodiment, a generic container is merged with a non-generic container to create a function-specific container to run a serverless function for the first time. This occurs upon reception of a request to execute the function and performed by a restore process. This process, implemented according an embodiment, is further discussed in FIG. 4.

FIG. 4 is an example flowchart 400 illustrating a method for a first-time execution of a serverless function while reducing the cold start latency according to an embodiment. The function is executed in a FaaS platform and the disclosed method allows for reduction of the function's cold start latency.

At S410, an event indicating a request for running a serverless function is received. The request is for a function whose image is included in a pre-created non-generic container (or a pod of a scalable FaaS platform 200, FIG. 2A). The event may be a synchronized event, an asynchronized event, or a polled event.

At S420, a generic container executed on a worker node is selected. In an embodiment, the selection is of a container (or pod) is not associated with any function. As noted above, the generic container may be run on the selected node.

At S430, the generic container on the selected node is transformed or otherwise re-configured to a function-specific container adapted to execute the requested function. In an embodiment, S430 includes merging the generic container with the non-generic container of the respective function. In an embodiment, S430 is initiated by a restore command which causes restoration of a pre-created non-generic container from the memory (from the checked-point), merger of the namespaces (of both containers), and configuration of non-generic resources with high consumption of computing resources (e.g., SecCom and PID namespace).

According to one implementation, the restoration of a container from the memory is performed using a memory restoration tool that allows restoration of a process from a user-space (and not the kernel of the operating system) in a combination with a copy-on-write technique. In an embodiment, the process restoration tool is modified to join namespaces already created in the containers and restore a process memory and instruction state of the pre-created non-generic container from the memory.

To further improve the restore time and memory usage, a kernel copy-on-write mechanism is implemented. Such a technique allows pre-loading of the memory and sharing of the memory across different instances of the same function, significantly reducing the restore time and improving memory usage. One example embodiment to implement the kernel copy-on-write mechanism is discussed above. In an embodiment, the copy-on-write is performed from a source container loaded with the contents of the pre-created non-generic container.

At S440, once the function-specific container is ready, a connection to the function-specific container established and the function is invoked, execution continues with S410 when another event is received. The connection, in an embodiment, is between a master node and a pod (hosting the function-specific container) in one of the worker nodes.

It should be noted that the time between readying a function-specific container and invoking the function for such container is the cold start time latency. When implementing the techniques disclosed herein such latency may be as low as tens of milliseconds. The techniques for reducing the cold start latency are further applicable when loading AI modules, for example, called by a function which are large memory consumers.

It should be noted that embodiments disclosed herein with respect to reduction the latency are agnostic to the execution environment of the containers. Further, the disclosed embodiments are agnostic and can support any size of the function's code or its associated files and libraries.

FIG. 5 is an example block diagram of a hardware layer 500 included in each node according to an embodiment. That is, each of the master node, operational node, and worker node is independently executed over a hardware layer, such as the layer shown in FIG. 5.

The hardware layer 500 includes processing circuitry 510 coupled to memory 520, a storage 530, and a network interface 540. In another embodiment, the components of the hardware layer 500 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 520 may be volatile (e.g., RAM, etc.), non-volatile (e.g., ROM, flash memory, etc.), or a combination thereof. In one configuration, computer readable instructions to implement one or more embodiments disclosed herein may be stored in the storage 530.

In another embodiment, the memory 520 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, configure the processing circuitry 510 to perform the various processes described herein.

The storage 530 may be magnetic storage, optical storage, and the like, and may be realized, for example, as flash memory or other memory technology, CD-ROM, Digital Versatile Disks (DVDs), or any other medium which can be used to store the desired information.

The network interface 540 allows the hardware layer 500 to communicate over one or more networks, for example, to receive requests for functions from user devices (not shown) for distribution to the pods and so on.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for reducing a cold start latency when invoking serverless functions on a Function as a Service (FaaS) platform, comprising:
migrating serverless functions to the FaaS platform;
per each migrated serverless function, pre-creating a plurality of software containers with non-generic resources;
distributing the pre-created non-generic software containers across computing nodes of the FaaS platform;
pre-creating a plurality of software containers with generic resources;
executing the plurality generic resources across computing nodes of the FaaS platform; and
upon receiving a first request to invoke a migrated serverless function, merging a respective non-generic software container with a generic software container.

2. The method of claim 1, wherein migrating serverless functions to the FaaS platform further comprising:
creating for each migrated serverless function, an image of the serverless function using based on the code configurations of the serverless function; and
saving each image of the serverless function in a storage.

3. The method of claim 1, wherein the non-generic resources in each of the pre-created non-generic software container define a respective migrated serverless function.

4. The method of claim 1, further comprising:
adding a memory check point to each non-generic software container.

5. The method of claim 1, further comprising:
adding each non-generic software container to a source container, wherein the source container provides the physical memory of each non-generic software container for its respective serverless functions.

6. The method of claim 1, wherein distributing the pre-created non-generic software containers further comprises:
assigning each worker node with an equal number of non-generic software containers for each migrated serverless function.

7. The method of claim 1, wherein each of the pre-created generic containers is a software container supporting any of the migrated serverless functions.

8. The method of claim 1, wherein pre-created generic containers, when executed, do not serve any specific pre-create non-generic container.

9. The method of claim 1, wherein the first request to invoke a migrated serverless function is a request for executing the migrated serverless function for the first time.

10. The method of claim 1, wherein merging the respective non-generic software container with a generic software container further comprises:
selecting a node executing the pre-create generic container;
transforming the pre-created generic container to a function specific container by merging the pre-created generic container with the respective pre-created non-generic container, wherein the function specific container is configured to execute the requested serverless functions.

11. The method of claim 1, wherein merging the respective non-generic software container with a generic software container further comprises:
restoring the pre-created non-generic container from its memory check-point; and
merging namespaces of the pre-created non-generic container and the selected pre-created generic container.

12. The method of claim 11, wherein restoring the pre-created non-generic container is performed using a process restoration tool.

13. The method of claim 12, further comprising:
loading the pre-created non-generic container from the physical memory using a kernel copy-on-write mechanism.

14. The method of claim 11, wherein the FaaS platform further comprises:
at least one master node executed over a hardware layer;
a plurality of worker nodes communicatively connected to the at least one master node and independently executed over a hardware layer;
wherein each of the plurality of worker nodes includes at least one pod, wherein each pod is configured to execution the function-specific software container.

15. The method of claim 14, further comprising:
establishing a connection between the at least one master node and a pod scheduled to execute the function.

16. A non-transitory computer readable medium having stored thereon instructions for causing processing circuitry circuitry to perform a process for reducing a cold start latency when invoking serverless functions on a FaaS platform, comprising:
migrating serverless functions to the FaaS platform;
per each migrated serverless function, pre-creating a plurality of software containers with non-generic resources;
distributing the pre-created non-generic software containers across nodes of the FaaS platform;
pre-creating a plurality of software containers with generic resources;
executing the plurality generic resources across nodes of the FaaS platform; and
upon receiving a first request to invoke a migrated serverless function, merging a respective non-generic software container with a generic software container.

17. A computing node operable in a Function as a Service (FaaS) cloud platform system, comprising:
processing circuitry; and
a memory, the memory containing instructions that, when executed by the processing circuitry, configure the system to:
migrate serverless functions to the FaaS platform;
per each migrated serverless function, pre-create a plurality of software containers with non-generic resources;
distribute the pre-created non-generic software containers across computing nodes of the FaaS platform;
pre-create a plurality of software containers with generic resources;
execute the plurality generic resources across computing nodes of the FaaS platform; and
merge a respective non-generic software container with a generic software container, upon receiving a first request to invoke a migrated serverless function.

18. The computing node of claim 1, wherein the computing node is further configured to:
create for each migrated serverless function, an image of the serverless function using based on the code configurations of the serverless function; and
save each image of the serverless function in a storage.

19. The computing node of claim 18, wherein the non-generic resources in each of the pre-created non-generic software container define a respective migrated serverless function.

20. The computing node of claim 18, wherein the computing node is further configured to:
add a memory check point to each non-generic software container.

21. The computing node of claim 18, wherein the computing node is further configured to:
add each non-generic software container to a source container, wherein the source container provides the physical memory of each non-generic software container for its respective serverless functions.

22. The computing node of claim 21, the computing node is further configured to:
assign each worker node with an equal number of non-generic software containers for each migrated serverless function.

23. The computing node of claim 21, wherein each of the pre-created generic containers is a software container supporting any of the migrated serverless functions.

24. The computing node of claim 18, wherein pre-created generic containers, when executed, do not serve any specific pre-create non-generic container.

25. The computing node of claim 18, wherein the first request to invoke a migrated serverless function is a request for executing the migrated serverless function for the first time.

26. The computing node of claim 18, wherein the computing node is further configured to:
select a node executing the pre-create generic container; and
transform the pre-created generic container to a function specific container by merging the pre-created generic container with the respective pre-created non-generic container, wherein the function specific container is configured to execute the requested serverless functions.

27. The computing node of claim 18, wherein the computing node is further configured to:
restore the pre-created non-generic container from its memory check-point; and
merge namespaces of the pre-created non-generic container and the selected pre-created generic container.

28. The computing node of claim 27, wherein restoring the pre-created non-generic container is performed using a process restoration tool.

29. The computing node of claim 28, wherein the computing node is further configured to:
load the pre-created non-generic container from the physical memory using a kernel copy-on-write mechanism.

30. The computing node of claim 29, wherein the FaaS platform further comprises:
at least one master node executed over a hardware layer;
a plurality of worker nodes communicatively connected to the at least one master node and independently executed over a hardware layer;
wherein each of the plurality of worker nodes includes at least one pod, wherein each pod is configured to execution the function-specific software container.
